(19) United States
(12) Patent Application Publication
(10) Pub. No.: US 2012/0048480 A1
(43) Pub. Date: Mar. 1, 2012

(54) Universal External Door/Window Sun-Shading Integration System for Building

(76) Inventor: Xianci Cai, Guangdong (CN)

(21) Appl. No.: 13/265,549

(22) PCT Filed: Aug. 26, 2009
(86) PCT No.: PCT/CN2009/073548

§ 371 Date: Oct. 21, 2011

(30) Foreign Application Priority Data
Apr. 21, 2009 (CN) 200910106751.0

(51) Int. Cl. E06B 9/11; E06B 7/16; E05B 65/00; E06B 9/56; E06B 7/02

(52) U.S. Cl. 160/98

(57) ABSTRACT

A universal external door/window sun-shading integration system for building includes a door/window frame (1), a door leaf/window sash (2), a screen window (3), a roller shutter (4), a ventilator (5), a concealed theft-proof device (6) and a controlling system, in which, the ventilator (5) is mounted in the door/window frame (1), the concealed theft-proof device (6) is provided at the outer side of the door/window frame (1), and the screen window (3), the roller shutter (4) and the ventilator (5) are controlled by the indoor controlling system.

### FIELD OF THE INVENTION

This invention relates to an integrating device of doors/windows for building, and specifically to a universal external door/window sun-shading integration system for building.

### BACKGROUND OF THE INVENTION

Building a door/window is an important part of outer enclosure of building door/window. It mainly bears functions such as sound insulation, ventilation, heat insulation, fire proof, sun shading and energy saving, water saving, safety, prevention of burglary, environmental friendliness, mosquito proof, air tightness, water tightness, etc. Lack of even one item will cause lack of door/window functions and bad living conditions. Later supplementation will destroy the structure and façade effect of the original wall and building door/window, thus affecting the building appearance.

With regard to existing building doors/windows, since they are not multi-functional, it is inconvenient for subsequent outer door/window secondary decoration supporting functions. In order to improve all functions of door/window, all items have to be added on the basis of existing door/window. In this way, the overall operation cost will be increased. Besides, it will be labor consuming, waste resources and affect building structure and building appearance.

### SUMMARY OF THE INVENTION

In order to solve the prior technical problem, this invention provides a universal external door/window sun-shading integration system for building. A concealed theft-proof device, a roller shutter, a screen window, a door leaf/window sash and a ventilator are integrated reasonably. The structure is compact. Functions needed for building outer enclosure door/window are finished at one time, realizing safety, comfortableness, energy-saving and environmental friendliness, etc.

This invention solves prior technical problems, provides a universal external door/window sun-shading integration system for building, comprising a door/window frame mounted in door/window openings of a building; a door leaf/window sash, a screen window and a roller shutter that are mounted in the door/window frame from inside to outside; this integration system comprises a ventilator and a concealed theft-proof device; the ventilator is embedded in the door/window frame; the concealed theft-proof device is mounted on the outer side of the door/window frame; this integration system also comprises an indoor controlling system which controls the roller shutter and the electrical ventilator respectively.

Further improvement of this invention: the roller shutter comprises a roller shutter box, a reel and a blade; the reel is arranged in the roller shutter box. A strip exit is arranged on the roller shutter box. The blade moves along the strip exit; a roller shutter cleaning device is arranged at the roller shutter opening.

A wool top that contacts with the blade is arranged at the strip exit, parallel to the blade; the inner wall of the roller shutter box is provided with a thermal insulation layer; the blade of the roller shutter is of thermal insulation type or self-lock type.

A through zigzag water drainage channel is arranged on the lower slide of the door/window frame. The inlet of the drainage channel is mounted on the bottom between the two lower slides; the outlet of the drainage channel is arranged on the outer side of the lower slide.

A safety block is arranged between two upper slides of the frame of the door leaf/window sash; a sealing block is arranged between two lower slides of the frame of the door leaf/window sash; the door leaf/window sash is of push-pull type, casement type, inside-open type, outside-open type or folded type; the glass of door leaf/window sash is of single-layer, laminated type or hollow; The ventilator is an electrical ventilator or a natural ventilator.

Compared with prior technology, this invention has the following beneficial effects: a concealed theft-proof device, a roller shutter, a screen window, a door leaf/window sash and a ventilator are integrated scientifically, realizing small land coverage, big effective area and elegancy and reliability. Meanwhile, all functions such as sound insulation, heat insulation, fire proof, sun shading and energy saving, water saving, safety, prevention of burglary, environmental friendliness, mosquito proof, air tightness, water tightness, roller shutter automatic cleaning, etc. are finished at one time. Besides, this invention can adopt the indoor controlling system for intelligent control, which is easily operated.

### DESCRIPTION OF THE DRAWINGS

FIG. 1 is the elevation sectional view of this universal external door/window sun-shading integration system for building;

FIG. 2 is another side sectional view of this integration system; and

FIG. 3 is the front view schematic diagram of this integration system.

### DETAILED DESCRIPTION OF THE PREFERRED EMBODIMENT

This invention is further specified as below with combination of description of figures and implementation.

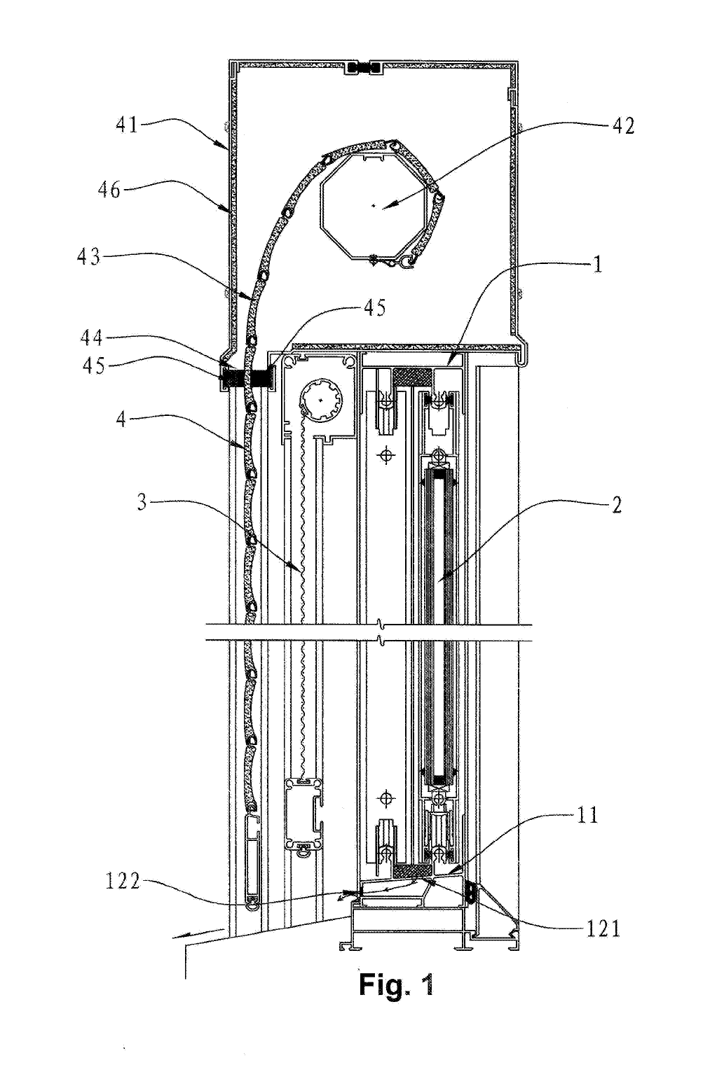

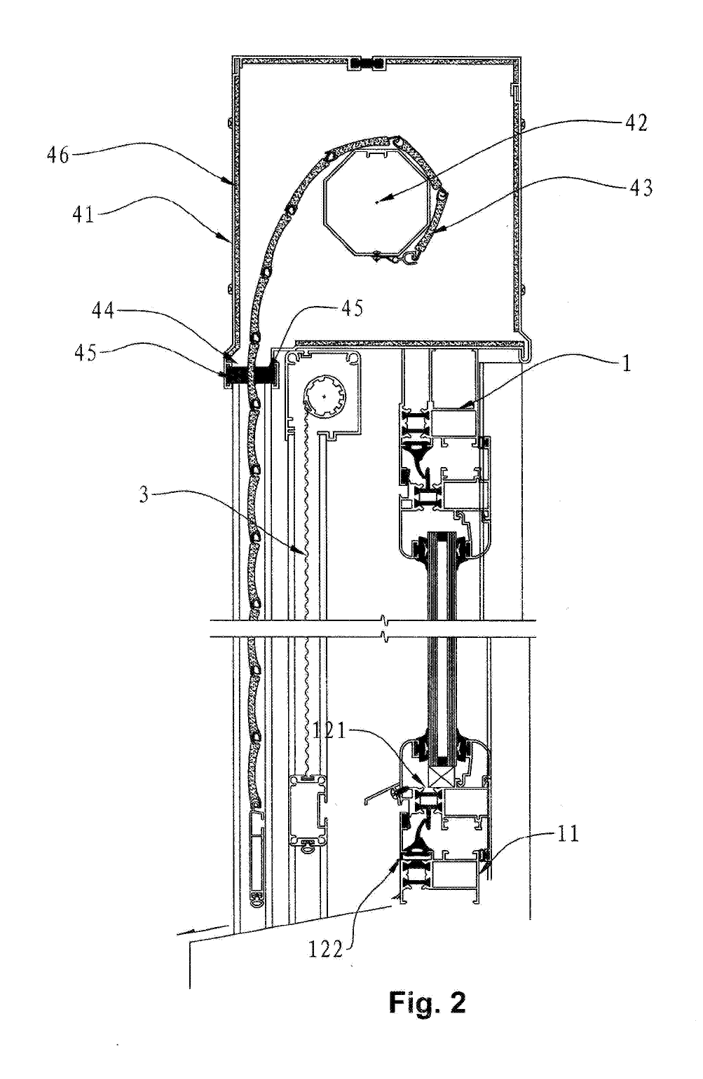

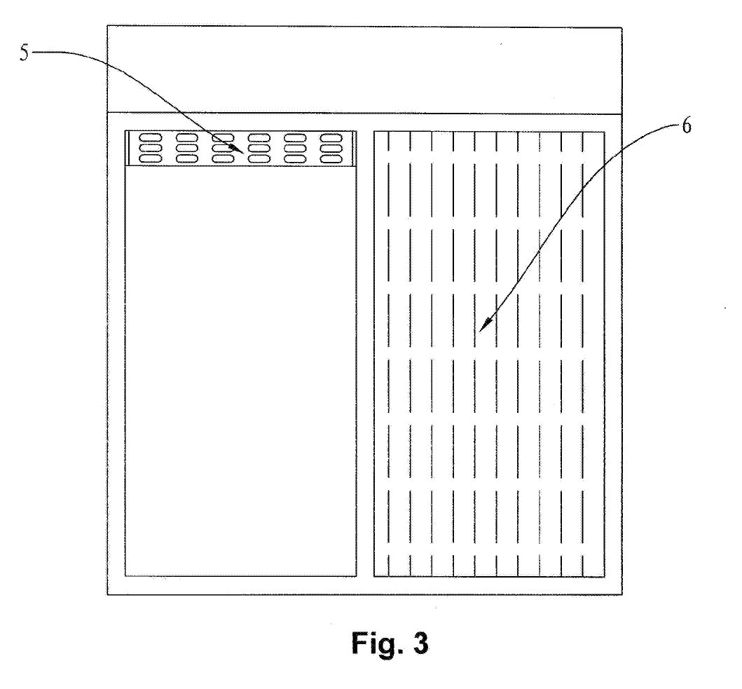

As shown in FIG. 1 to FIG. 3, a universal external door/window sun-shading integration system for building comprises a door/window frame 1, a door leaf/window sash 2, a screen window 3, a roller shutter 4, a ventilator 5, a concealed theft-proof device 6 and a controlling system. The door/window frame 1 is embedded in the wall at the building door/window reserved opening, or mounted in the metallic frame of the building door/window opening. The door leaf/window sash 2, the screen window 3, the roller shutter 4 and the concealed theft-proof device 6 are mounted from inside to outside successively. A lot of patterns of door leaf/window sash 2 are available, subject to user's preference; the gauze of screen window 3 is used to keep mosquito indoor; the blade of the roller shutter 4 is used to keep external sunshine out of room; the concealed theft-proof device 6 is mounted on the outer side of door/window frame 1 to improve door/window safety, so as to prevent stealer from going inside for breach of the law and prevent children from falling indoor; ventilator 5 is also arranged in the door/window frame 1 (The ventilator comprises the door leaf/window sash which is arranged in the door/window frame 1), for indoor/outdoor air replacement. This integration system is in the shape of strip which facilitates transportation, packaging and installation. Besides, this integration system also comprises an indoor controlling system (not indicated in the figure) which controls the roller shutter 4 and the ventilator 5 respectively. It adjusts full-open, half-open or close of the blade of the roller shutter 4 directly indoor. Meanwhile, it can control the ventilator 5.

The roller shutter 4 of this invention comprises a roller shutter box 41, a reel 42 and a blade 43; the roller shutter box 41 is a square hollow shell. Since the blade 43 has some thickness and volume, the blade 43 has big volume after it has wound up the reel 42. In this way, the roller shutter box 41 is also required to have big volume. Limited by the overall layout of the integration system, the roller shutter box 41 is arranged on the inner side above the door/window opening. The reel 42 rotates and drives the blade 43 to wind up the reel 42. The rotation of the reel 42 can be realized by the controlling motor of the controlling system. The blade 43 comprises a lot of uniwafers that are connected by connecting pieces. The uniwafer is provided with thermal insulation material, i.e. thermal insulation blade; the connecting piece may also be of burglar-proof self-locking mechanism, i.e. self-locking blade. The reel 42 is arranged in the roller shutter box 41. The roller shutter box 41 is provided with a strip exit 44. The blade 43 moves along the strip exit 44. A roller shutter cleaning device is arranged at the roller shutter opening. The roller shutter cleaning device is a wool top 45 that is parallel to the blade 43, arranged at the strip exit 44, and contacts with the blade 43. The wool top 45 can be used to clean dirt and dust on the surface of the blade to keep the blade 43 clean and elegant. Besides, a thermal insulation layer 46 is arranged on the inner wall of the roller shutter box 41.

When rainwater drops on door/window, it will penetrate into the door/window from the clearance and accumulates together. Since there is a groove between two lower slides of the door leaf/window sash 2, the groove often has water logging. Therefore, a through zigzag water drainage channel is arranged on the lower slide 11 of the door/window frame 1. The inlet of the drainage channel 121 is mounted on the bottom between the two lower slides 11; the outlet of the drainage channel 122 is arranged on the outer edge of the lower slide. The inlet 121 and the outlet 122 are far from each other at the orthographic projection of the door/window frame 1. In this way, zigzag water drainage channel blocks linear propagation of sound, which effectively lowers noise and isolates sound.

Besides, after the integration system of this invention has been mounted on the door leaf/window sash 2, a safety block is mounted between two upper slides of the frame of the door leaf/window sash. Meanwhile, a sealing block is embedded between two lower slides. The door leaf/window sash is supported by top and bottom at the same time, guaranteeing connection between door leaf/window sash and the upper and lower slides, preventing the door leaf/window sash from falling, which causes accidents. Meanwhile, the air tightness and water tightness of door/window are improved.

The door leaf/window sash 2 of the integration system of this invention may adopt various prior familiar door leaf/window sash structures, such as push-pull type, casement type, inside-open type or outside-open type; the glass of door leaf/window sash can be of single-layer, laminated type or hollow, subject to preference. The ventilator 5 is an electrical ventilator or a natural. A prior ventilator structure may be used directly to control indoor/outdoor air replacement, thus guaranteeing the indoor air quality.

This invention integrates the concealed theft-proof device, the roller shutter, the screen window, the door leaf/window sash and the ventilator scientifically, realizing small land coverage and big effective area. All functions needed for building door/window outer enclosure are integrated at one time. Besides, it is elegant and reliable. Meanwhile, it realizes functions such as sound insulation, heat insulation, fire proof, sun shading and energy saving, water saving, safety, prevention of burglary, environmental friendliness, mosquito proof, air tightness, water tightness, roller shutter automatic cleaning, etc. at one time. Besides, this invention can adopt the indoor controlling system for intelligent control, which is easily operated.

Industrial Use

The universal external door/window sun-shading integration system for building of this invention can be widely applied to modern building, or transformed on the basis of prior building. The concealed theft-proof device, the roller shutter, the screen window, the door leaf/window sash and the ventilator are integrated scientifically, realizing small land coverage and big effective area, elegancy and reliability. Meanwhile, it realizes functions such as sound insulation, heat insulation, fire proof, sun shading and energy saving, water saving, safety, prevention of burglary, environmental friendliness, mosquito proof, air tightness, water tightness, roller shutter automatic cleaning, etc. at one time. Besides, this invention can adopt the indoor controlling system for intelligent control of doors and windows, which is easily operated.

Above is the further specifications of this invention based on optimal implementation mode and it cannot be regarded that implementation of this invention is limited to these specifications. Under the precondition of not escaping from concept of this invention, ordinary technicians within the technical field of this invention may make simple deductions or replacements, which shall be regarded as within the scope of protection of this invention.

What is claimed is:

1. A universal external door/window sun-shading integration system for building comprising a door/window frame mounted in door/window openings of a building; and a door leaf/window sash, a screen window and a roller shutter mounted in the door/window frame from inside to outside; wherein the integration system comprises a ventilator and a concealed theft-proof device; the ventilator is embedded in the door/window frame; the concealed theft-proof device is mounted on the outer side of the door/window frame; the integration system also comprises an indoor controlling system which controls the roller shutter and the ventilator respectively.

2. The universal external door/window sun-shading integration system for building of claim 1, wherein the roller shutter comprises a roller shutter box, a reel and a blade; the reel is arranged inside the roller shutter box, the roller shutter box is provided with a strip exit, the blade moves along the strip exit; a roller shutter cleaning device is arranged at the roller shutter opening.

3. The universal external door/window sun-shading integration system for building of claim 2, wherein the roller shutter cleaning device is a wool top that is parallel to the blade, arranged at the strip exit, and contacts with the blade.

4. The universal external door/window sun-shading integration system for building of claim 2, wherein the inner wall of the roller shutter box is provided with a thermal insulation layer.

5. The universal external door/window sun-shading integration system for building in any one claim of claims 1-4, wherein the blade of the roller shutter is of thermal insulation type or self-lock type.

6. The universal external door/window sun-shading integration system for building of claim 1, wherein a through zigzag water drainage channel is arranged on the lower slide of the door/window frame, the inlet of the drainage channel is mounted on the bottom between the two lower slides; the outlet of the drainage channel is arranged on the outer side of the lower slide.

7. The universal external door/window sun-shading integration system for building in any one claim of claims 1-4, wherein a safety block is arranged between two upper slides of the frame of the door leaf/window sash.

8. The universal external door/window sun-shading integration system for building in any one claim of claims 1-4, wherein a sealing block is arranged between two lower slides of the frame of the door leaf/window sash.

9. The universal external door/window sun-shading integration system for building in any one claim of claims 1-4, wherein the door leaf/window sash is of push-pull type, casement type, inside-open type or outside-open type; the glass of door leaf/window sash is of single-layer, laminated type or hollow.

10. The universal external door/window sun-shading integration system for building in any one claim of claims 1-4, wherein the ventilator is an electrical ventilator or a natural ventilator.
